(19) United States
(12) Patent Application Publication
(10) Pub. No.: US 2019/0260004 A1
(43) Pub. Date: Aug. 22, 2019

(54) BOARD FOR CONNECTING BATTERY CELLS

(71) Applicant: Thomas Krämer, St. Julian's (MT)

(72) Inventor: Thomas Krämer, St. Julian's (MT)

(73) Assignee: E-Seven Systems Technology Management Ltd, Valletta (MT)

(21) Appl. No.: 16/401,984

(22) Filed: May 2, 2019

Related U.S. Application Data
(63) Continuation of application No. PCT/EP2017/077981, filed on Nov. 1, 2017.

(30) Foreign Application Priority Data
Nov. 2, 2016 (DE) 10 2016 120 834.5

(51) Int. Cl. H01M 2/20; H01M 2/10; H01M 10/613

(52) U.S. Cl. CPC H01M 2/202; H01M 10/613; H01M 2/1016

(57) ABSTRACT

A board for connecting battery cells, which is formed in part from an electrically non-conductive material. The board has on a first side and on a second side in each case at least one electrically and thermally conductive contacting section, and each contacting section is connected to each other. A planar covering of an electrically and thermally conductive material forming the second side is arranged on the non-electrically conductive material of the board. A portion of the covering forms a contacting section of the second side, and a contacting section is arranged on a first side of the non-electrically conductive material facing away from the covering. A lead-through element extends through the non-electrically conductive material, so as to make an electrical and a thermal connection between contacting sections of each side and a heat flow can be picked up by the covering and dissipated from the board.

### CROSS-REFERENCE TO RELATED PATENT APPLICATIONS

This patent application is a continuation of PCT/EP2017/077981, filed Nov. 1, 2017, which claims priority to German Application No. 10 2016 120 834.5, filed Nov. 2, 2016, the entire teachings and disclosure of which are incorporated herein by reference thereto.

### FIELD

The present invention concerns a board for connecting battery cells, which is formed in part from an electrically non-conductive material, wherein the board has on a first side and on a second side in each case at least one electrically and thermally conductive contacting section, and wherein each contacting section is electrically and thermally conductively connected to each other contacting section.

### BACKGROUND

From the state of the art it is known that battery cells within a battery can be electrically and thermally connected to each other via a board. This allows an electric current and a heat flow to be distributed as evenly as possible within a battery by means of such a board. In particular, this prevents local thermal hot spots from forming in the battery, which is particularly detrimental to battery operation. It is desirable that the operating temperature of the battery is kept as low as possible. The present invention is therefore based on the object of providing a board that is suitable for dissipating a heat flow from a battery.

### BRIEF SUMMARY

The object is solved by a board of the aforementioned type, which in accordance with the invention is configured in that a planar covering of an electrically and thermally conductive material forming the second side is arranged on the non-electrically conductive material of the board, wherein at least a portion of the covering forms a contacting section of the second side, and wherein at least one contacting section is arranged on a first side of the non-electrically conductive material facing away from the covering, and wherein at least one electrically and thermally conductive lead-through element extends through the non-electrically conductive material, so that an electrical and a thermal connection of the contacting sections on the first side with the contacting sections on the second side is made by the lead-through element and a heat flow can be picked up by the covering and dissipated from the board.

The covering is made of an electrically and thermally conductive material. Electrically conductive materials often offer the advantage that they are also thermally highly conductive. The covering is arranged in the electrically non-conductive material of the board. The covering is preferably configured planar. For example, the covering can be a plate made of an electrically and thermally conductive material on which the electrically non-conductive material is arranged. The electrically non-conductive material is preferably applied to the covering in a planar manner. However, the covering does not necessarily have to be planar. Thus, according to the invention, it is also possible that the covering is made of individual conductive elements or a texture of conductive elements. Deviating geometric shapes of the covering are also possible according to the invention.

At least one electrically and thermally conductive lead-through element is passed through the electrically non-conductive material and the core. It electrically conductively connects the at least one contacting section on the first side of the board to the at least one contacting section on the second side of the board. It can connect the two contacting sections either directly or indirectly, for example via further electrically and thermally conductive elements.

According to the invention, the electrically non-conductive material can be made of a common substrate material that is used for boards or circuit boards. The electrically and thermally conductive contacting sections as well as the electrically and thermally conductive lead-through elements are preferably made of a metal. Copper is particularly preferred. This is advantageous because copper has particularly good electrical and thermal conductivity. The board can be produced at a reasonable price using production methods for circuit boards known to the person skilled in the art.

Preferably, the covering is formed over an entire surface. This is to be understood in such a way that there are no openings in the covering. It can have a thickness of 0.1 to 0.5 mm according to a possible configuration.

The covering is preferably led out of an edge of the board or is exposed on the edge. The covering is therefore suitable for conducting thermal energy out of the side of the board. The covering can be led out of the board or can be exposed at several edges.

According to a particular embodiment of the invention, the covering is thermally conductively connected to a thermally conductive heat dissipating element or the covering forms a thermally conductive heat dissipating element, wherein the heat dissipating element has a first planar section extending in a plane of the board, and wherein the heat dissipating element has a second planar section extending in another plane oriented at a right angle to the plane of the board. Such a heat dissipation element is particularly suitable for dissipating a heat flow from a battery. The first planar section is suitable for leading a heat flow out of a cell arrangement of a battery in which the board is arranged. The second planar section of the heat dissipation element is suitable for dissipating this heat flow to a heat sink. For this purpose, the second planar section can lie flat against a heat sink. This heat sink can be a housing which is disposed around a cell arrangement in which the board is arranged. However, the heat sink can be another cooling element. Since the second planar section of the heat dissipation element is planar, a particularly large heat flow can be dissipated via the second planar section to a heat sink.

According to the invention, the covering of the board can be made of a metal. Most metals not only have very good electrical conductivity, but also very good thermal conductivity. According to the invention, the covering can be made of copper. Alternatively, the covering can also be made of another metal or a metal alloy.

The covering is particularly preferably made of aluminum. Aluminum has very good thermal conductivity, but also low density. This allows the board to be made particularly light, which can have a significant effect on the weight of a battery that contains a plurality of boards that are configured according to the invention.

The board may be configured in accordance with the invention such that an electrically and thermally conductive connecting section is arranged on the first side of the board, which electrically and thermally conductively connects the contacting sections to one another on the first side of the board, and wherein an electrical fuse is assigned to each of the contacting sections on the first side of the board and the connecting section on the first side of the board is connected to each contacting section on the first side of the board via an electrical fuse assigned to this contacting section, such that the contacting sections on the first side of the board are electrically secured with respect to the connecting section. This is in particular advantageous if an internal resistance of a battery cell to which the board is connected breaks down due to a fault in the battery cell, so that an exceedingly high current is conducted through this battery cell. In this case, an electrical fuse is triggered which is assigned to a contacting section of the board which is electrically and thermally conductively connected to the defective battery cell. An excessive current therefore cannot flow from the defective battery cell into the connection section. As a result, further battery cells which are electrically and thermally conductive abutting at further contacting sections of the board are electrically protected against the defective battery cell.

It is particularly preferred that the lead-through elements are arranged such that they electrically and thermally conductively connect the connecting section on the first side of the board to the at least one contacting section on the second side of the board, such that each contacting section on the first side is secured against each other contacting section on the first side of the board and against each contacting section on the second side of the board by at least one electrical fuse. This ensures that all contacting sections are electrically secured against each other. Such an arrangement can avoid the need to provide an unnecessarily large number of fuses. In particular, the arrangement according to the invention does not require that conductive lead-through elements, which connect the contacting sections of the first side and the second side of the board with each other, must be dimensioned as fuses. However, it is also possible to use alternative configurations of the invention, according to which lead-through elements are dimensioned as fuses. According to the invention, it is in particular possible that lead-through elements are not arranged in a connecting section, but each directly connect contacting sections on the first side and on the second side of the board to each other.

It is advantageous if the connecting section is formed as a planar, electrically and thermally conductive layer on the first side of the board. If the connection section is formed as a planar layer, then it has a very high electrical and thermal conductivity and is therefore particularly suitable for distributing an electrical and a thermal current between the contacting sections on the first side of the board. Alternatively, the connecting section can be designed as a composite of conductor tracks which are electrically and thermally conductively connected to one other. The advantage of a composite of conductor tracks is that less electrically and thermally conductive material has to be used for the connecting section. Additional space remains on the board for other components that can be arranged on the non-conductive material.

According to a particular configuration of the invention, the connection section on the first side is connected to the covering on the second side through the electrically non-conductive material. Thus it is not necessary that the connecting section on the first side of the board is directly connected to a contacting region on the second side in an electrically and thermally conductive manner via a contacting element. Instead, there may be an electrically and thermally conductive connection between the connection section on the first side and the covering on the second side. An electrical and a thermal current can be conducted by the covering to at least one contacting section on the second side of the board.

According to a further configuration of the invention, around each contacting section in the connection section on the first side of the board, a plurality of lead-through elements are arranged uniformly spaced apart from the contacting section. It has been shown that by providing several lead-through elements, an electrical and thermal current can be conducted particularly well from the first side of the board to the second side of the board. It has been found to be advantageous if the lead-through elements are arranged near the contacting sections in the connecting section on the first side of the board. A circular arrangement of the lead-through elements around the contacting sections is particularly suitable. A number of six to twelve lead-through elements has been found to be particularly advantageous.

According to the invention, the at least one lead-through element can be arranged on an inner edge of a lead-through recess which passes through the non-conductive material. The recess may be circular or of any other shape. The lead-through element is preferably a metal layer which, according to the invention, can be evaporated or printed onto the inner edge of the lead-through recess. The lead-through recess can be drilled or punched into the non-conductive material. However, the lead-through element may also be configured differently and, in particular, may not necessarily be arranged along a lead-through recess through the non-conductive material. For example, the lead-through element can be inserted into the non-conductive material as a rivet element in accordance with a possible configuration.

According to the invention, the contacting sections can be elevated on the first side and/or on the second side of the board with respect to a plane defined by a surface of the first side or the second side of the board, respectively. An elevated element of the contacting section preferably has a flat surface or a surface with a relief shape adapted to a shape of an end terminal of a battery cell. This improves contacting of the contacting section with a battery cell. The contacting section is preferably configured in such a way that it protrudes between 0.1 mm and 0.3 mm from the plane defined by the surface of the first side or the surface of the second side of the board, respectively.

It is advantageous if the contacting sections have elevated contacting points. The contact points can be used to establish a well-defined electrically and thermally conductive connection between the contacting sections and adjacent battery cells.

Preferably the board is flexible. For this purpose, the board can be made of flexible and/or elastic materials. For example, the electrically non-conductive material may be made of an elastic polymer. The electrically non-conductive material can be formed from a polyimide, which is preferably Kapton. Kapton is chemically highly resistant and has very high breakdown field strength. The electrically and thermally conductive material applied to the board, of which the contacting sections, the connecting section on the first side of the board, the covering and the at least one lead-through element are made, has sufficient flexibility if it is a metal. However, the amount of metal applied should be dimensioned such that it will not be damaged when the board is bent, which could cause sections of the board to diminish or lose their electrical and thermal conductivity.

Particularly preferably, at least one cooling line is provided in the board to cool the board. The cooling line can pass through the board in a plane formed by the board. According to the invention, several cooling lines can be provided in the board. The cooling line can pass through the covering of the board according to the invention.

Preferably, below each contacting section, an elastic material is arranged which is elastically deformable under the action of a pressing force on the contacting section. According to the invention, the elastic material may be located in the non-conductive material below the contacting section. If a contact force is applied to the contacting section, both the contacting section and the elastic material are deformed. This makes it possible to establish a particularly good electrically and thermally conductive connection between a contacting section and a battery cell. Due to the local deformation of the board, an undesired deformation of the board in further sections of the board or even damage to the board can be avoided in case battery cells are pressed against the contacting sections.

Preferably at least one additional contact is provided on the interconnection of conductor tracks or on the planar, electrically and thermally conductive layer on the first side of the board and/or on the covering on the second side of the board. Such a contact is not intended to be contacted by a battery cell. A battery management system can be connected to such a contact so that, for example, a voltage applied to the board can be measured.

Preferably at least one further contact is provided on the board. The further contact can be connected, for example, to a measuring device which is mounted on the board or provided in the board. This may be a temperature sensor. In accordance with the invention, the contact can also be used to connect a bus system which can be used to read out and/or control measuring devices provided on the board.

The present invention further concerns a battery having a cell arrangement, wherein the cell arrangement comprises a plurality of battery cells, wherein the cell arrangement comprises at least two battery sections and each battery section consists of a plurality of battery cells, wherein the battery cells of the battery sections are aligned such that end terminals of the battery cells of the respective battery section are located in a common first contacting plane and that end terminals of the battery cells of the respective battery section are located in a common second contacting plane, wherein the battery sections are arranged adjacent to one another, wherein in each case a first contacting plane of a battery section faces a second contacting plane of an adjacently arranged battery section, and wherein the contacting planes are aligned parallel to one another, wherein an at least partially electrically and thermally conductive connecting plate having a first side and a second side is arranged between at least two successive battery sections, which has on the first side and on the second side in each case at least one thermally and electrically conductive contacting section, wherein the end terminals facing the first side of this connecting plate are thermally and electrically conductively connected to the at least one contacting section of this first side, and wherein the end terminals facing the second side of this connecting plate are thermally and electrically conductively connected to the at least one contacting section of this second side, and wherein contacting sections of the connecting plate are electrically and thermally conductively connected to one another via the connecting plate. In accordance with the invention, the connecting plate is configured as a board, which is configured as described above. The covering is thermally conductively connectable to a heat sink such that a heat flow can be picked up through the covering and dissipated from the cell arrangement onto the heat sink.

The battery contains several battery cells in each battery section. Preferably the battery cells are round cells. These have proven to be particularly resistant to mechanical stresses.

The cell arrangement can be enclosed by a thermally conductive housing in accordance with the invention. As the housing is thermally conductive, it is suitable for absorbing heat from the cell arrangement as a heat sink and optionally transferring it to other heat sinks to which it is thermally conductively connected. The previously described heat dissipation element can be thermally conductively connected to the housing. The housing is preferably made of a metal, preferably iron, aluminum or a metal alloy. Such a housing is suitable for protecting the cell arrangement from external influences. The housing preferably has two openings on which the pressure plates are placed. The housing may comprise further elongated recesses as ventilation slots according to the invention.

According to the invention, the battery cells can be arranged such that first end terminals of a contacting plane of a first battery section are arranged directly opposite to second end terminals of a contacting plane of a second battery section, so that all the battery cells of a battery section are arranged in alignment with the battery cells of an adjacent battery section. Thus, groups of battery cells of several battery sections are arranged in rows.

Preferably, positive end terminals of a battery section are directly electrically and thermally conductively abutting to negative end terminals of an adjacent battery section. Accordingly, two or more battery cells are connected in series without directly adjacent battery cells being separated from each other by a board. Such a structure can be provided if sufficient distribution of an electric current and a heat flow within a battery is possible even with a small number of boards within the cell array. Whether this is the case is largely determined by the capacitive and other properties of the battery cells.

Preferably each battery cell has a positive and a negative end terminal and the battery cells of the battery sections are aligned such that all positive end terminals of the battery cells of the respective battery section lie in the first contacting plane and that all negative end terminals of the battery cells of the respective battery section lie in the second contacting plane, wherein the end terminals connected to the at least one contacting section of the first side are electrically and thermally conductively connected to each other via the connecting plate, the end terminals connected to the at least one contacting section of the second side being electrically and thermally conductively connected to one another via the connecting plate, and the end terminals connected to the at least one contacting section of the first side being electrically and thermally conductively connected to the end terminals connected to the at least one contacting section of the second side via the connecting plate, so that the battery cells are electrically conductively connected to one another in an electrical and thermal series and parallel circuit. The advantage of such an arrangement is that an electric current and a thermal current can be distributed over the entire cell arrangement. If a battery cell in a battery section fails, the performance of the battery is only slightly impaired because there are other functioning battery cells in the battery section. A positive end terminal or a negative end terminal is to be understood as a positive pole or a negative pole of a battery cell, respectively.

It is preferred when a battery start region and a battery end region are defined by the end terminals located in the two outer contact planes of the battery, wherein a respective pressure plate is arranged at the battery start region and the battery end region, wherein the pressure plates are connected to one another via tension elements and thereby the battery cells abutting to the at least one board are pressed to the at least one board.

The components within the cell arrangement are thereby pressed together. Herein, the pressure plates each exert a contact force on the battery cells. According to the invention, the pressure plate may exert the contact pressure at the battery start section or on the battery end section directly on the battery cells. The pressure plate may abut directly to the end terminals of the battery cells. Alternatively, the pressure plate can exert the contact force at the battery start section or at the battery end section also indirectly on the battery cells. Between the pressure plate and the battery cells, an additional layer may be provided according to the invention. This additional layer may be configured electrically non-conductively and/or elastically.

According to the invention, the pressure plates can be formed planar, but different configurations of pressure plates are also possible. The tension elements are each connected to the pressure plates. Advantageously, no electrical connection exists between the battery cells and the tension elements. Herein, the tension elements are clamped in such a way between the pressure plates that they exert a tensile force on the pressure plates. Due to the tensile force, the pressure plates can in turn exert the already described contact force on the cell arrangement. The contact force is transmitted across all battery sections of the cell arrangement within the battery. Therefore, the battery cells are particularly well contacted with the at least one board within the cell arrangement, as an area between two electrically and/or thermally contacting elements may be enlarged due to the contact force.

The tension elements can be in the form of rods, tubes or other elongated elements. Preferably the rods are made of a metal, particularly made of steel. Alternatively, the rods can also be made of a particularly stable plastic or composite material.

It is advantageous if the pressure plates are configured as metal plates. Metal plates are sufficiently stable so that a tensile force can be transmitted from the tension elements to the cell arrangement. The metal plates can be made with different thicknesses depending on a desired tensile force. If a high tensile force is desired, the metal plate must be made particularly thick. Preferably, the metal plate is 3 to 20 mm in thickness, most preferably 5 mm in thickness. According to the invention, the metal plates can be formed of copper, aluminum or other very highly thermally conductive material. Alternatively, it is possible not to make the pressure plates of metal. Hence, the pressure plates may be made of a hard plastic according to the invention.

Preferably, the tension elements are passed through tension element recesses in the pressure plates, wherein the tension elements are bolted in the tension element recesses and/or are bolted to the pressure plates by means of nuts. A threaded connection allows a precise adjustment of the tensile forces exerted by the tension elements on the pressure plates. However, according to the invention, other fixing means can also be used in order to fix the tension elements to the tension element recesses in such a way that the tension elements exert a tensile force on the pressure plates.

### BRIEF DESCRIPTION OF THE DRAWING

Further advantageous forms of implementation of the invention are shown in the drawings. Therein:

FIG. 1 shows a schematic representation of a board according to the invention in a view on a first side of the board,

FIG. 2 shows a schematic representation of the board according to FIG. 1 in a view on a second side of the board,

FIG. 3 shows a schematic representation of the board according to FIGS. 1 and 2 lead-through recess in a sectional view,

FIG. 4 shows a schematic representation of the board according to FIGS. 1 to 3 with an elastic material in a sectional view,

FIG. 5 shows a schematic representation of a cell arrangement of a battery according to the invention with a board,

FIG. 6 shows a schematic representation of a section of the cell arrangement of the battery according to FIG. 5 in a sectional view, and

FIG. 7 a schematic diagram of the battery according to FIG. 5 and FIG. 6 with a housing.

### DETAILED DESCRIPTION

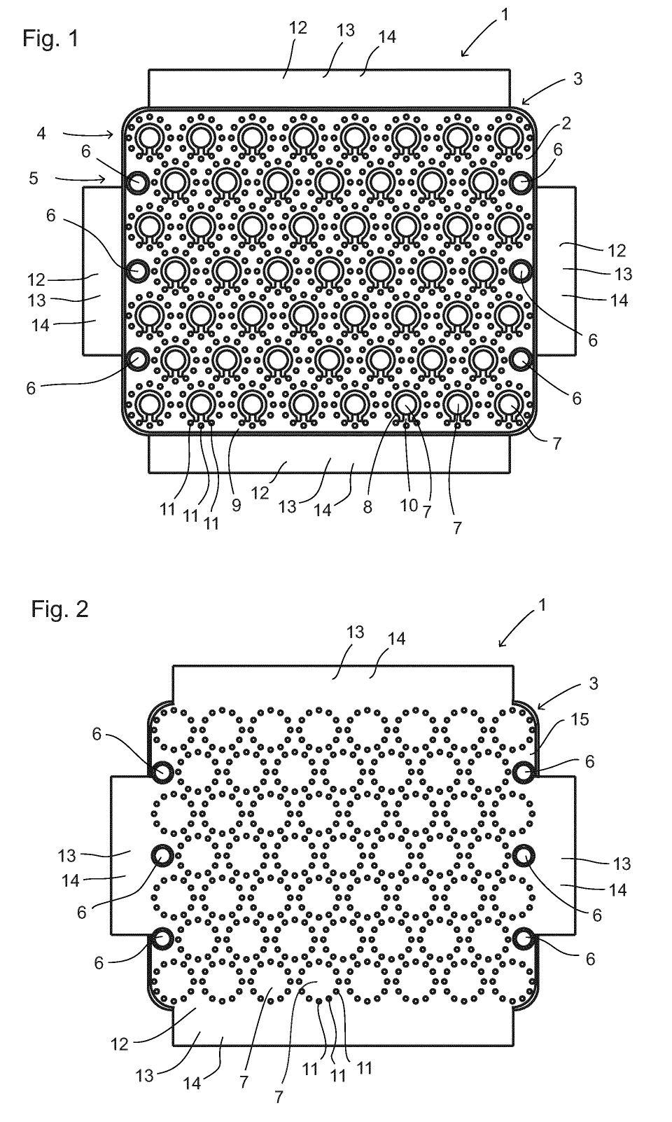

FIG. 1 shows a schematic representation of a board 1 according to the invention in a view on a first side 2 of the board. Here, the board 1 is part of a cell arrangement 3 with battery cells arranged offset in first cell planes 4 and in second cell planes 5 (not shown). Board 1 is suitable for cell arrangements 3 with seven first and second cell levels 4 and 5, with eight and seven battery cells being arranged in the first and second cell levels 4 and 5, respectively (not shown). Board 1 has tension element recesses 6 through which tension elements (not shown) can pass through.

Board 1 is partly made of an electrically non-conductive material. On the first side of the board 1, copper is applied in a planner manner as an electrically and thermally conductive material to the electrically non-conductive material. The copper material has several contacting sections 7. These are suitable for contacting the end terminals of battery cells. For this purpose, the contacting sections 7 are elevated. The contacting sections 7 are separated from a connecting section 9 by insulating sections 8 made of an electrically non-conductive material. The connecting section 9 is planar. It connects the contacting sections 7 with each other electrically and thermally conductively. An electrically and thermally conductive conductor track 10, which is dimensioned as a fuse, passes through each insulation section 8. Thereby, the contacting sections 7 are electrically secured against each other.

Around each insulation section 8 and thus also around each contacting section 7, several lead-through recesses 11 are arranged in a circular shape. In each lead-through recess 11, a lead-through element (not shown) is arranged. The lead-through element is made of copper and connects the connecting section 9 of the first side 2 of board 1 with a second side (not shown) of board 1 electrically and thermally conductively. A current flowing from a battery cell into a contacting section 7 can thus be passed through the conductor track 10 and the connecting section to the second side of board 1. As the contacting sections 7 on the first side 2 of the board 1 are electrically secured with respect to the connecting section 9, they are also secured against contacting sections (not shown) on the second side of board 1.

On the second side of board 1 (not shown), a covering 12 made of copper is situated, which partially extends laterally into areas outside board 1. In these areas outside the board 1, the covering 12 forms a heat dissipation element 13. Four heat dissipation elements 13 are shown here, each with a first planar section 14. At each heat dissipation element 13, there is also a second planar section, which is not visible due to the perspective shown.

FIG. 2 shows a schematic representation of board 1 according to FIG. 1 in a view on a second side 15 of board 1. On the second side 15 of board 1, the covering 12 is arranged which is planar. In the covering 12, contacting sections 7 are arranged, which are suitable for contacting with end terminals of battery cells. Around each contacting section 7, several lead-through recesses 11 are arranged in a circular shape. Lead-through elements, which are not shown, are arranged in board 1 in the lead-through recesses 11 as described above.

The four heat dissipation elements 13, each with a first planar section 14, are also shown here. Also on the second side of board 1, the tension element recesses 6 are visible, through which tension elements can be passed.

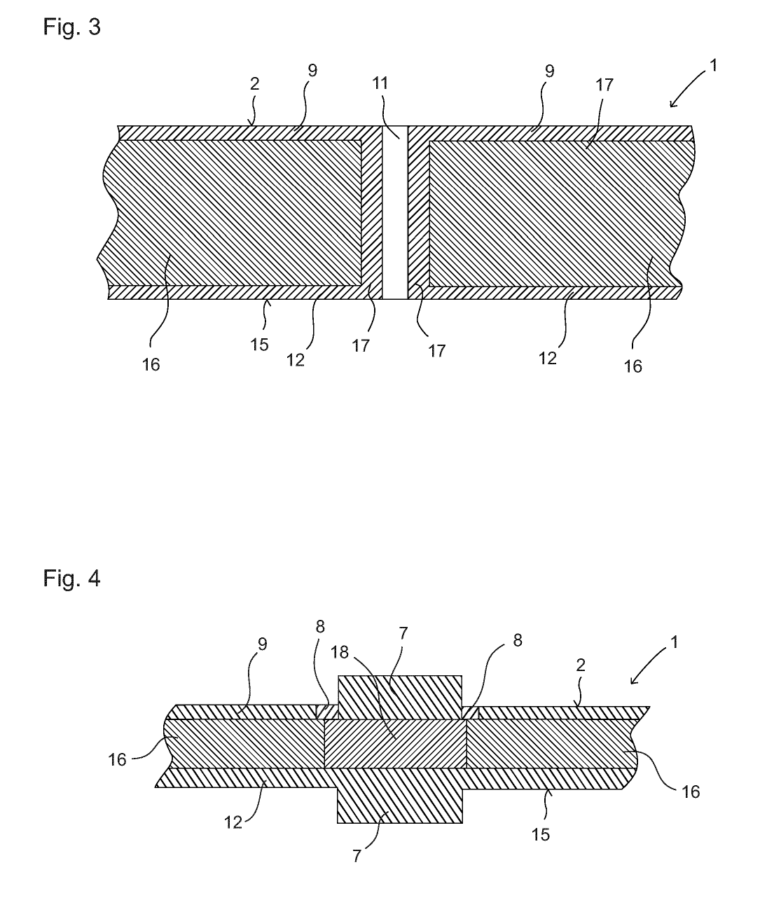

FIG. 3 shows a schematic view of board 1 according to FIGS. 1 and 2 with a lead-through recess 11 in a sectional view. Board 1 comprises an electrically non-conductive substrate material 16. The electrically and thermally conductive covering 12 is arranged on the substrate material 16. On the first side 2 of the board 1, a copper layer forms the connecting section 9. A lead-through recess 11 is passed through the board 1. It passes through the connecting section 9, the substrate material and the covering 12. A lead-through element 17 made of copper is applied as a thin layer to the substrate material 16 in a planar manner in the lead-through recess 11. An electrical and thermal current may therefore be passed through the substrate material 16 and be dissipated from board 1 via covering 12.

FIG. 4 shows a schematic representation of board 1 according to FIGS. 1 to 3 with an elastic material 18 in a sectional view. The board 1 comprises the non-electrically conductive substrate material 16 and the covering 12. On a first side 2 of the board 1, a copper layer forms the connection section 9. On the second side 15 of the board 1, a copper layer forms the covering 12. The first side 2 and the second side 15 of the board 1 have elevated contacting sections 7. A non-electrically conductive insulation section 8 is arranged around the contacting section 7 on the first side 2 of board 1. The elastic material 18 is arranged inside the board 1 between the contacting sections 7. When a contact force is exerted to the contacting section 7, both the contacting section 7 and the elastic material 18 are deformed. This contributes to the stability of board 1.

FIG. 5 shows a schematic representation of a cell arrangement 3 of a battery 19 according to the invention with a board 1. In the cell arrangement 3, several battery cells 20 are arranged next to each other in a battery section 21. The battery cells 20 arranged in a battery section 21 are connected in parallel. The parallel interconnection of the battery cells 20 is made possible by several boards 1 according to the invention within the cell arrangement 3. For this purpose, end terminals of the battery cells 20 are electrically and thermally conductively connected to the boards 1. The boards 1 are each arranged between two battery sections 21. Battery cells 20 of adjacent battery sections 21 are connected in series by the boards 1 arranged between them. The battery cells 20 in cell arrangement 3 are thus connected to each other both in parallel and in series.

A battery start region 22 and a battery end region 23 are formed by positive end terminals and by negative end terminals of battery cells 20 in battery 19, respectively. Battery start region 22 and battery end region 23 are connected to outer boards 1. The outer boards 1 connect the end terminals of battery cells 20 electrically and thermally conductively. A pressure plate 24 is each arranged on the side of the outer boards 1 facing away from the battery start region 22 and the battery end region 23, respectively. The pressure plate 24 is made of copper. It therefore has particularly high heat conductivity. The pressure plate 24 is electrically isolated from the outer boards 1, such that the pressure plate 24 does not carry current during operation of the battery 19.

The pressure plates 24 are connected to each other by tension elements 25. The tension elements 25 are screwed to the pressure plates 24 in such a way that they exert a tensile force on the pressure plates 24. This compresses the cell arrangement 3. In particular, the battery cells 20 are pressed against the boards 1. This increases the contact area between the end terminals of the battery cells 20 and the boards 1, so that an electric and a thermal current can be distributed better between the battery cells 20 and the boards 1 and thus also distributed better over the entire cell arrangement 3. This avoids local thermal hotspots within the battery 19. Furthermore, due to the invention cell arrangement 3 pressed by the tensile elements 25 and the pressure plates 24 according to the invention, the battery 19 according to the invention is particularly resistant to mechanical stresses.

In order to ensure that the battery cells 20 are securely held within the cell arrangement 3, the battery cells 20 are enclosed by several positioning plates 26. The positioning plates 26 enclose the battery cells 20 in the battery sections 21 in a form-fitting manner. As a precise contacting of the end terminals of the battery cells 20 to the boards 1 is necessary, the positioning plates 26 are here arranged in the vicinity of the boards 1.

The boards 1 each have a covering 12, which is laterally led out of the boards 1. Outside the boards 1, the covering 12 forms a heat dissipation element 13. Heat can be dissipated from the cell arrangement 3 via the heat dissipation element 13. The heat dissipation element 13 has a first planar section 14 extending in a plane of the board 1 and a second planar section 27 extending in another plane oriented at a right angle to the plane of the board 1. The second planar section 27 is suitable for thermally conductive connection to a housing (not shown) or to a heat sink (not shown), such that a heat flow can be dissipated from board 1 to the housing or to the heat sink, respectively.

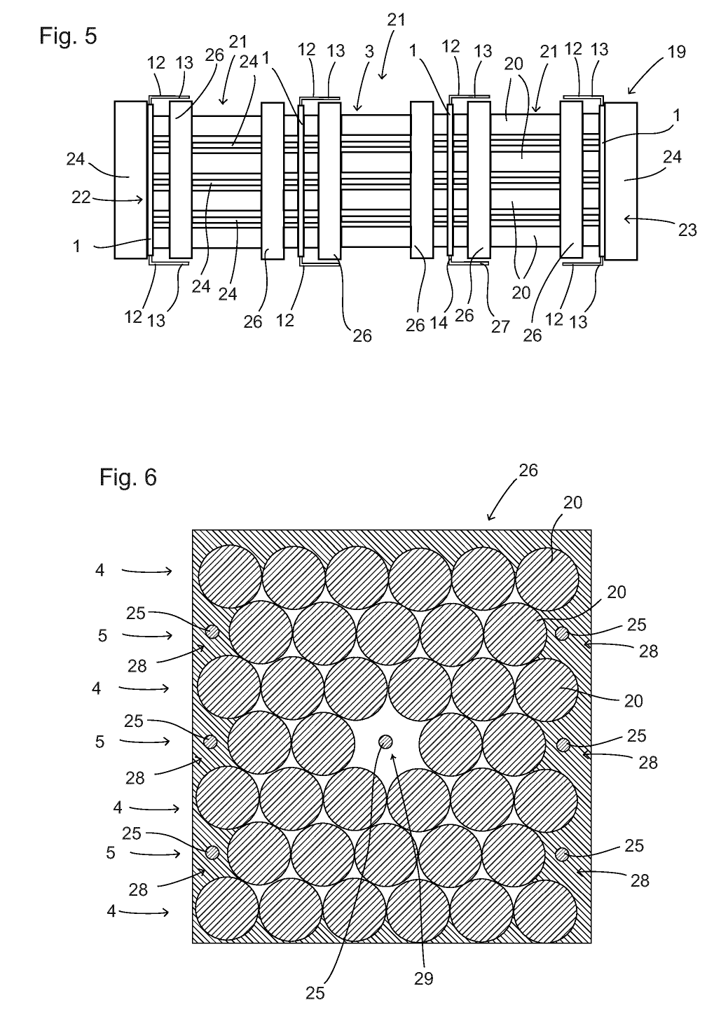

FIG. 6 shows a schematic representation of a section of the cell arrangement of the battery 19 according to FIG. 5 in a sectional view. The battery cells 20 are arranged in first cell levels 4 and second cell levels 5. The battery cells 20 are directly adjacent to each other. The second cell levels 5 each have one battery cell 20 less than the first cell levels 4. This results in outer passage sections 28. Tension elements 25 can be passed through the outer passage sections 28. The outer passage sections 28 allow as many battery cells 20 as possible to be arranged on the smallest possible cross-sectional area of a cell arrangement 3. For example, to insert a tension element 25 into the edge area of a battery section 21, it is not necessary to remove an entire battery cell 20. Instead, only one battery cell 20 is removed from a second cell level 5. The removal of one battery cell 20 from the second cell level 5 results in two outer passage sections 28. One or more tension elements 25 can be passed through each outer passage section 28. Here, one tension element 25 is passed through each outer passage section 28. In order to achieve uniform stabilization of the cell arrangement 3, however, an inner passage section 29 is also provided in which no battery cell 20 is arranged. A tension element 25 is passed through the inner passage section 29.

The battery cells 20 are enclosed in the battery section 21 by the positioning plate 26. Tension element recesses 6 are provided in the positioning plate 26, through which the tension elements 25 are passed through into the outer passage sections 28 and in the inner passage section 29.

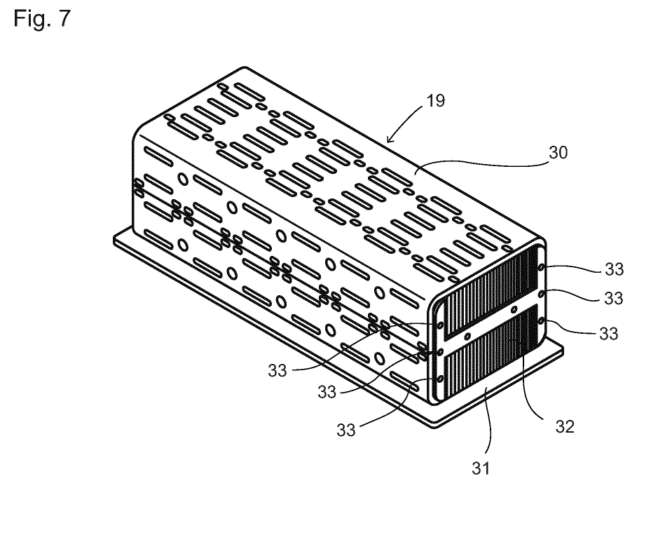

FIG. 7 shows a schematic representation of an invention battery 19 with a housing 30. The housing 30 is made of iron and encloses a cell arrangement 3 according to the invention with boards 1. Inside the housing 30, heat dissipation elements 13 can be connected to the housing 30 such that a heat flow can be dissipated from the cell arrangement 3 to the housing 30. The housing 30 is firmly connected to a mounting plate 31, which serves as a heat sink. The housing 30 is closed at two ends by pressure plates 24. The pressure plates 24 have cooling fins 32, such the pressure plates 24 help to cool the cell arrangement 3 inside the housing 30. Tension elements 25, which are not shown, are passed through the pressure plates 24 and fixed to the pressure plates 24 by means of nuts 33.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A board for connecting battery cells, which is formed in part from an electrically non-conductive material,
wherein the board has on a first side and on a second side in each case at least one electrically and thermally conductive contacting section, and
wherein each contacting section is electrically and thermally conductively connected to each other contacting section,
wherein a planar covering of an electrically and thermally conductive material forming the second side is arranged on the non-electrically conductive material of the board,
wherein at least a portion of the covering forms a contacting section of the second side, and
wherein at least one contacting section is arranged on a first side of the non-electrically conductive material facing away from the covering,
wherein a plurality of electrically and thermally conductive lead-through elements extend through the non-electrically conductive material, so that an electrical and a thermal connection of the contacting sections on the first side with the contacting sections on the second side is made by the lead-through element and a heat flow can be picked up by the covering and dissipated from the board,
wherein on the first side of the board, an electrically and thermally conductive connecting section is arranged, which electrically and thermally conductively connects the contacting sections to one another on the first side of the board,
wherein an electrical fuse is assigned to each of the contacting sections on the first side of the board, and
wherein the connecting section on the first side of the board is connected to each contacting section on the first side of the board via an electrical fuse assigned to this contacting section, such that the contacting sections on the first side of the board are electrically secured with respect to the connecting section.

2. The board according to claim 1, wherein the covering is formed over an entire surface.

3. The board according to claim 1, wherein the covering is led out of an edge of the board or is exposed on the edge.

4. The board according to claim 1, wherein the covering is thermally conductively connected to a thermally conductive heat dissipation element,
wherein the heat dissipating element has a first planar section extending in a plane of the board, and
wherein the heat dissipating element has a second planar section extending in another plane oriented at a right angle to the plane of the board.

5. The board according to claim 1, wherein the covering is made of a metal.

6. The board according to claim 5, wherein the covering is made of aluminum.

7. The board according to claim 1, wherein the lead-through elements are arranged such that they electrically and thermally conductively connect the connecting section on the first side of the board to the at least one contacting section on the second side of the board, such that each contacting section on the first side is secured against each other contacting section on the first side of the board and against each contacting section on the second side of the board by at least one electrical fuse.

8. The board according to claim 1, wherein the connecting section is formed as a planar, electrically and thermally conductive layer on the first side of the board.

9. The board according to claim 1, wherein the connecting section is formed as a composite of conductor tracks which are electrically and thermally conductively connected to one another.

10. The board according to claim 9, wherein the connecting section on the first side of the board is connected to the covering on the second side of the board through the electrically non-conductive material.

11. The board according to claim 1, wherein around each contacting section in the connecting section on the first side of the board, a plurality of lead-through elements are arranged uniformly spaced apart from the contacting section.

12. The board according to claim 1, wherein the lead-through elements are arranged on an inner edge of a lead-through recess which passes through the non-conductive material.

13. The board according to claim 1, wherein the contacting sections on the first side and/or on the second side of the board are elevated with respect to a plane defined by a surface of the first side or the second side of the board, respectively.

14. The board according to claim 1, wherein the contacting sections have elevated contacting points.

15. The board according to claim 1, wherein the board is flexible.

16. The board according to claim 1, wherein below each contacting section, an elastic material is arranged which is elastically deformable under the action of a pressing force on the contacting section.
